(19) United States
(12) Patent Application Publication
(10) Pub. No.: US 2022/0180716 A1
(43) Pub. Date: Jun. 9, 2022

(54) MAINTENANCE NOTIFICATION DEVICE AND METHOD OF USING SAME

(71) Applicant: MeFeCon LLC, New York, NY (US)

(72) Inventors: Caryn Ann Conlon, New York, NY (US); Michael Francis Conlon, Seaford, NY (US)

(21) Appl. No.: 17/112,843

(22) Filed: Dec. 4, 2020

(51) Int. Cl. G08B 5/22

(52) U.S. Cl. CPC G08B 5/22

(57) ABSTRACT

An exemplary notification device has a frame to securely attach it to a standing structure. The exemplary notification device also has a display coupled to the frame with at least one section displaying one of an activity or a period of time. The notification device has a processor electrically connected to the display and configured to make at least one real-time visible update to the at least one section of the display after the period of time elapses. The processor also delivers information related to the at least one update to a location external of the notification device.

### FIELD OF THE INVENTION

Facility operations and maintenance services may be required for both large and small locations, such as, for example, hospitals, airports, public transportation terminals (trains, buses, and cars), office buildings, food/eating establishments, universities and schools, warehouses, and factories. Typically, the maintenance of a facility may take place either during use of the facility by members of the facility, the public, patrons, employees, or others.

Facility operations and maintenance services regularly involve closing space inside and outside of buildings to complete work tasks. At times these closures interrupt the operations taking place at the facility.

Notice of facility and operations maintenance typically includes signage, such as propped signs or placards, that indicate to viewers that they take caution in and around the location of the maintenance.

There is a need for ready notification of the maintenance as well as providing immediate collection and transmission of data related to the maintenance activity for reporting and analysis purposes.

### SUMMARY

An exemplary notification device may comprise a frame with at least one portion to securely attach to a standing structure. The exemplary notification device may further comprise a display that is coupled to the frame and has at least one section for visibly conveying one of an activity or a period of time. Additionally, there may be a battery for powering the display and a processor electrically connected to the display and configured to make at least one real-time visible update to the at least one section of the display after the period of time elapses. Further additionally, the processor may be further configured to deliver information related to the at least one update to a location external of the notification device.

An exemplary notification device may comprise a frame with at least one portion to securely attach to a standing structure. The exemplary notification device may further comprise a display that is coupled to the frame and has at least one section for visibly conveying one of an activity or a period of time. Additionally, there may be a battery for powering the display and a processor electrically connected to the display and configured to make at least one real-time visible update to the at least one section of the display after the period of time elapses. Further additionally, the processor may be further configured to deliver information related to the at least one update to a location external of the notification device when the period of time elapses.

An exemplary notification device may comprise a frame with at least one portion to securely attach to a standing structure. The exemplary notification device may further comprise a display that is coupled to the frame and has at least one section for visibly conveying one of an activity or a period of time. Additionally, there may be a battery for powering the display and a processor electrically connected to the display and configured to make at least one real-time visible update to the at least one section of the display after the period of time elapses. Further additionally, the processor may be further configured to deliver information related to the at least one update to a location external of the notification device. For example, the location external of the notification device may be a location that provided information that caused the processor to make the at least one real-time visible update to the at least one section of the display processor.

An exemplary notification device may comprise a frame with at least one portion to securely attach to a standing structure. The exemplary notification device may further comprise a display that is coupled to the frame and has at least one section for visibly conveying one of an activity or a period of time. Additionally, there may be a battery for powering the display and a processor electrically connected to the display and configured to make at least one real-time visible update to the at least one section of the display after the period of time elapses. Further additionally, the processor may be further configured to deliver information related to the at least one update to a location external of the notification device. For example, the display may comprise a plurality of sections for visibly conveying an activity, and each one of the plurality of sections may include a first time and a second time within the period of time.

An exemplary notification device may comprise a frame with at least one portion to securely attach to a standing structure. The exemplary notification device may further comprise a display that is coupled to the frame and has at least one section for visibly conveying one of an activity or a period of time. Additionally, there may be a battery for powering the display and a processor electrically connected to the display and configured to make at least one real-time visible update to the at least one section of the display after the period of time elapses. Further additionally, the processor may be further configured to deliver information related to the at least one update to a location external of the notification device. Additionally, there may also be an adaptor connected to the frame.

An exemplary notification device may comprise a frame with at least one portion to securely attach to a standing structure. The exemplary notification device may further comprise a display that is coupled to the frame and has at least one section for visibly conveying one of an activity or a period of time. Additionally, there may be a battery for powering the display and a processor electrically connected to the display and configured to make at least one real-time visible update to the at least one section of the display after the period of time elapses. Further additionally, the processor may be further configured to deliver information related to the at least one update to a location external of the notification device. Additionally, there may also be a substantially tamper-resistant adaptor connected to the frame.

An exemplary notification device may comprise a frame with at least one portion to securely attach to a standing structure. The exemplary notification device may further comprise a display that is coupled to the frame and has at least one section for visibly conveying one of an activity or a period of time. Additionally, there may be a battery for powering the display and a processor electrically connected to the display and configured to make at least one real-time visible update to the at least one section of the display after the period of time elapses. Further additionally, the processor may be further configured to deliver information related to the at least one update to a location external of the notification device. Additionally, there may also be an adaptor integrated with the frame.

An exemplary notification device may comprise a frame with at least one portion to securely attach to a standing structure. The exemplary notification device may further comprise an LCD display that is coupled to the frame and has at least one section for visibly conveying one of an activity or a period of time. Additionally, there may be a battery for powering the display and a processor electrically connected to the display and configured to make at least one real-time visible update to the at least one section of the display after the period of time elapses.

An exemplary notification device may comprise a frame with at least one portion to securely attach to a standing structure. The exemplary notification device may further comprise a display with at least one LED that is coupled to the frame and has at least one section for visibly conveying one of an activity or a period of time. Additionally, there may be a battery for powering the display and a processor electrically connected to the display and configured to make at least one real-time visible update to the at least one section of the display after the period of time elapses.

An exemplary notification device may comprise a frame with at least one portion to securely attach to a standing structure. The exemplary notification device may further comprise a display that uses an LCD screen and at least one LED, both of which being coupled either directly or indirectly to the frame and has at least one section for visibly conveying one of an activity or a period of time. Additionally, there may be a battery for powering the display and a processor electrically connected to the display and configured to make at least one real-time visible update to the at least one section of the display after the period of time elapses.

An exemplary notification device may comprise a frame with at least one portion to securely attach to a standing structure. The exemplary notification device may further comprise a display with either an LCD screen or an LED that is coupled to the frame and has at least one section for visibly conveying one of an activity or a period of time. Additionally, there may be a battery for powering the display and a processor electrically connected to the display and configured to make at least one real-time visible update to the at least one section of the display after the period of time elapses. Further additionally, the processor may be further configured to deliver information related to the at least one update to a location external of the notification device. Additionally, there may also be a substantially tamper-resistant adaptor connected to the frame.

An exemplary method of controlling a remote maintenance device may have the following steps (although not necessarily in this order): receiving a scheduled maintenance task, displaying a duration of the scheduled maintenance task via an electronic display coupled to a frame located at a site for the scheduled maintenance task, updating the electronic display on or before the duration has elapsed, and delivering information related to the updating of the display to a remote source.

An exemplary method of controlling a remote maintenance device may have the following steps (although not necessarily in this order): receiving a scheduled maintenance task, displaying a duration of the scheduled maintenance task via an electronic display coupled to a frame located at a site for the scheduled maintenance task, updating the electronic display on or before the duration has elapsed, updating a display of information other than the duration of the scheduled maintenance task, and delivering information related to the updating of the display to a remote source.

An exemplary method of controlling a remote maintenance device may have the following steps (although not necessarily in this order): receiving a scheduled maintenance task, displaying a duration of the scheduled maintenance task via an electronic display coupled to a frame located at a site for the scheduled maintenance task, updating the electronic display on or before the duration has elapsed, updating a display of information other than the duration of the scheduled maintenance task (e.g., a text message on the electronic display), and delivering information related to the updating of the display to a remote source.

An exemplary method of controlling a remote maintenance device may have the following steps (although not necessarily in this order): receiving a scheduled maintenance task, displaying a duration of the scheduled maintenance task via an electronic display coupled to a frame located at a site for the scheduled maintenance task, updating the electronic display on or before the duration has elapsed, updating a display of information other than the duration of the scheduled maintenance task (e.g., a text message on the electronic display related to the scheduled maintenance task), and delivering information related to the updating of the display to a remote source.

An exemplary method of controlling a remote maintenance device may have the following steps (although not necessarily in this order): receiving a scheduled maintenance task, displaying a duration of the scheduled maintenance task via an electronic display coupled to a frame located at a site for the scheduled maintenance task, updating the electronic display on or before the duration has elapsed, updating a display of information other than the duration of the scheduled maintenance task (e.g., a text message on the electronic display related to the scheduled maintenance task) one of a plurality of electronic displays, and delivering information related to the updating of the display to a remote source.

An exemplary method of controlling a remote maintenance device may have the following steps (although not necessarily in this order): receiving a scheduled maintenance task, displaying a duration of the scheduled maintenance task via an electronic display coupled to a frame located at a site for the scheduled maintenance task, updating the electronic display on or before the duration has elapsed, updating a display of information other than the duration of the scheduled maintenance task (e.g., a text message on the electronic display related to the scheduled maintenance task) one of a plurality of electronic displays, and delivering information related to the updating of the display to a remote source that delivered the scheduled maintenance task.

An exemplary notification system may have at least one notification device comprised of a frame that may have at least one portion to securely attach the at least one notification device to a standing structure. The system may further have a display having at least one section for visibly conveying one of an activity or a period of time and being coupled to the frame. Additionally, a battery may be provided for powering the display. Further additionally, a processor may be electrically connected to the display and configured to make at least one real-time visible update to the at least one section of the display after the period of time elapses. Moreover, the processor may be further configured to deliver information related to the at least one update to a server. According to this exemplary embodiment of an exemplary notification system, the system further includes the standing structure to which the frame may be securely attached.

An exemplary notification system may have at least one notification device comprised of a frame that may have at least one portion to securely attach the at least one notification device to a standing structure. The system may further have a display having at least one section for visibly conveying one of an activity or a period of time and being coupled to the frame. Additionally, a battery may be provided for powering the display. Further additionally, a processor may be electrically connected to the display and configured to make at least one real-time visible update to the at least one section of the display after the period of time elapses. Moreover, the processor may be further configured to deliver information related to the at least one update to a server. According to this exemplary embodiment of an exemplary notification system, the system further includes the standing structure to which the frame may be securely attached and at least one server.

An exemplary notification system may have at least one notification device comprised of a frame that may have at least one portion to securely attach the at least one notification device to a standing structure. The system may further have a display having at least one section for visibly conveying one of an activity or a period of time and being coupled to the frame. Additionally, a battery may be provided for powering the display. Further additionally, a processor may be electrically connected to the display and configured to make at least one real-time visible update to the at least one section of the display after the period of time elapses. Moreover, the processor may be further configured to deliver information related to the at least one update to a server. According to this exemplary embodiment of an exemplary notification system, the system further includes the standing structure to which the frame may be securely attached and at least one server which may deliver instructions to make at least one real-time visible update to the at least one notification device.

### DESCRIPTION OF THE DRAWINGS

FIG. 1 illustrates an exemplary maintenance notification device according to an exemplary embodiment.

FIGS. 2A-C illustrate different vantage points of another exemplary maintenance notification device according to a further exemplary embodiment.

FIG. 3 illustrates an exemplary maintenance notification method.

FIG. 4 illustrates another exemplary maintenance notification method.

FIG. 5 illustrates an exemplary maintenance notification system.

FIG. 6 illustrates yet another exemplary maintenance notification method.

In the drawings like characters of reference indicate corresponding parts in the different and interchangeable and interrelated figures. Parts and components of each figure may be substitutes for other components in other figures to achieve the various methods and embodiments disclosed herein. Methods and protocols disclosed in any embodiment may be run in any order so as to affect their disclosed goals and/or enable performance of the systems as described. Additionally, any one embodiment may utilize any method or protocol described and in any portions, sequences, and combinations thereof.

### DETAILED DESCRIPTION

Facility and operations maintenance equipment typically includes one or more cleaning utilities (e.g., brooms, mops, brushes, towels, disinfectants and other cleansing sprays, vacuums, scrubbers, electric disinfectant sprayers, power washers, sanitizing machinery, buffers), a cleaning utility carrier (e.g., a cart or other multi-layered rolling device, cleaning caddy), and one or more signs in the form of foldable barriers, prop signs, plastic maintenance gates, security barriers, safety signs, stanchions, doors, partitions or window.

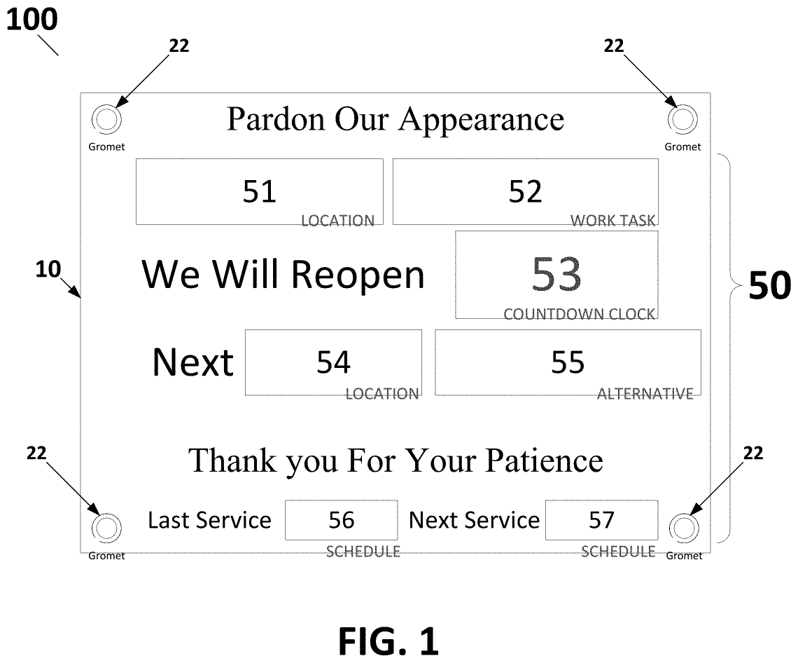

With reference to FIG. 1, an exemplary maintenance notification device (“MND”) 100 may take the form of a sign having one or more electronic displays 50 (e.g., LED arrays, LCD or OLED screens, covered and uncovered variants of any of the foregoing) held in place on the MND 100 by a frame 10. The front of the MND 100 may be a smooth surface with a combination of printed material and one or more digital display screens. Additionally, the back of the MND 100 may provide for a frame 10 with accessibility to the power source (not shown). An exemplary frame 10 may be made of durable material in which there may be a number of electronic components that power and support display 50, which may comprise LCD displays and/or interactive touch screens, and any computer processing software.

An exemplary frame 10 may be made of metal, plastic, recycled material, rubber, or a combination thereof. Frame 10 may also be constructed of any other material or materials whose composition or combined compositions allow for the multiple embodiments disclosed herein, including embodiments in which an electronic display 50, which may comprise one or more separate electronic display sections 51-57 may be arranged in different parts of MND 100. In an exemplary embodiment, display 50 may be one screen having different portions, e.g., sections 51-57, dedicated to displaying different types of information. While a certain number of sections 51-57 of display 50 may be illustratively provided, an exemplary MND 100 may have more or less sections in display 50 depending on needs.

In a further alternative embodiment, display 50 may be a dynamic user interface, such as, for example, offering digital scroll-down list of options or providing access to local or remote computer systems as a virtual machine or via a gateway. In an exemplary embodiment, a display 50 in the form of a touch screen may provide a scroll-down list of categories: Location, Work Task Name, Time to Complete Work Task, and Name of Labor. Any number and categories may be added to and/or preprogrammed into MND 100 for selection via display 50.

In a preferred embodiment, a maintenance worker may activate a screen icon on display 50 of an exemplary MND 100 upon commencement of a maintenance task, such as, for example a “start trigger,” and a screen icon upon completion of the task, such as, for example a “finish trigger.” Accordingly, the MND 100 may utilize display 50 to project in response to a commencement selection and/or a separate selection of maintenance operation a “work task” or maintenance activity. Additionally, MND 100 may utilize display 50 to project at the same time as the maintenance activity a timing feature, such as, for example, a countdown clock, to show a time by which the maintenance activity is to be completed. An exemplary MND 100 may also allow users of MND 100 to either add from or subtract from the timing feature of display 50 if a maintenance activity is being completed faster and/or slower than expected. In an exemplary aspect of this preferred embodiment, MND 100 may collect the data obtained via display 50 in a memory located on the device MND 100 and/or recorded on a memory located remotely from MND 100 to allow for access by others, e.g., maintenance company management, facilities management, vendors, customers of the service provider using MND 100. In a preferred embodiment, the information recorded and gathered by MND 100 may be electronically transmitted to a website for ready access, analysis, export, and comparison to prior maintenance activities.

In an alternative embodiment, display 50 may be comprised of one or more separate screens housing the aforementioned sections 51-57, for example, a first screen may have sections 51-53, a second screen may have sections 54 and 57, and a third screen may have sections 55-56. According to this alternative embodiment, each of the first, second, and third screens may be configured to display information in one or all sections in either the same or different form as any other screen. Thus, it is contemplated that certain screens may provide information in sections that are capable of touchscreen or capacitive touch technology while other screens may use illuminating LEDs or display-only LCD technologies. Those skilled in the art would understand the various screen and display technologies may be used side-by-side in display 50 via its various sections 51-57 to convey information in accordance with the disclosures herein. In a preferred embodiment, display 50, including its various sections, e.g., sections 51-57, may be of a size and consist of fonts and colors that are prominent and easily legible.

According to the illustrative embodiment provided by FIG. 1, an exemplar MND 100 may have one or more openings 22 for receiving affixing devices known to those skilled in the art, e.g., grommets, screws, hooks, wire, rope. Openings 22 may be reception holes for grommets in a preferred embodiment.

Each of electronic display 50, which includes its constituent sections 51-57, are suitably sized, shaped, and illuminated to allow for viewers to visually observe the information they provide. In an exemplary embodiment, display 50 may be situated to be at eye level with a user. Alternatively, display 50 may be able to convey information via one or more of its sections so as to be seen by individuals with 20/20 vision or 20/80 vision (and/or their metric equivalents). In a further alternative, display 50 may be able to convey information via one or more of its sections so as to be seen by individuals with less than perfect vision, e.g., vision that is at or above 20/200 (or its metric equivalent).

The types of information that may be provided by display 50 may include, for example, location, work task being undertaken at the location of the MND 100, a timer or clock indicating length of work, scheduled completion, scheduled return of maintenance, last time of maintenance, any future maintenance locations, and future times of maintenance at any future maintenance location. In a preferred embodiment, an exemplary MND 100 may have a display screen 50 comprised of multiple LED screens having a first section 51 that may provide information related to the present location of MND 100 and/or the location of a first maintenance task, a second section 52 that may provide information related to the type of maintenance being provided at the location of a first maintenance task, a third section 53 that may provide information on when the location receiving the first maintenance task will no longer require maintenance, a fourth section 54 that may provide information for an alternative location not receiving maintenance, a fifth section 55 that may provide information on the proximity of the alternative location to the location of the first maintenance task, a sixth section 56 that may provide information on the last maintenance task at the location of MND 100, and a seventh section 57 that may provide information on the next maintenance task at the location of MND 100. While not required, in a preferred embodiment, each of sections 51-57 of display 50 may be surrounded by text or other indicia helping to explain or emphasize the information conveyed thereby.

As described herein, the information provided by display 50 via one or more of its sections 51-57 may be controlled by the user of MND 100 using touchscreen technology or by remote access grants such as keys, scanners, and/or wired connections to MND 100, e.g., USB, ethernet, WiFi, biometric, and QR codes. For sections of display 50 that are touchscreen accessible, the information provided may be changed by users of MND 100 and the changes recorded in memory and/or in a remote repository, such as, for example, a website, remote database, or in systems utilizing scheduling/timing/block chain tracking of tasks/activities. In an alternative embodiment, those sections of display 50 which may not be touchscreen accessible, e.g., LED displays and/or display-only LCD screens, may nevertheless deliver the information provided thereby either separately and/or in conjunction with the information provided by MND 100 to memory and/or to a remote repository. For example, in an exemplary embodiment, an MND 100 may allow a user to access a section 51 of display 50 to change from a first work task to a second work task. A section 52 comprised of LEDs may be displaying a hazard or warning associated specifically with the first work task selectable by section 51. When MND 100 receives the change in work task via section 51, MND 100 may send the information from section 51 to a memory or to a remote repository where in either location the information may be accessed by a program and determined that the MND 100 must change the information conveyed by section 52, e.g., the lighting/arrangement/pattern of illumination activity of LEDs, to reflect the second work task selected in section 51.

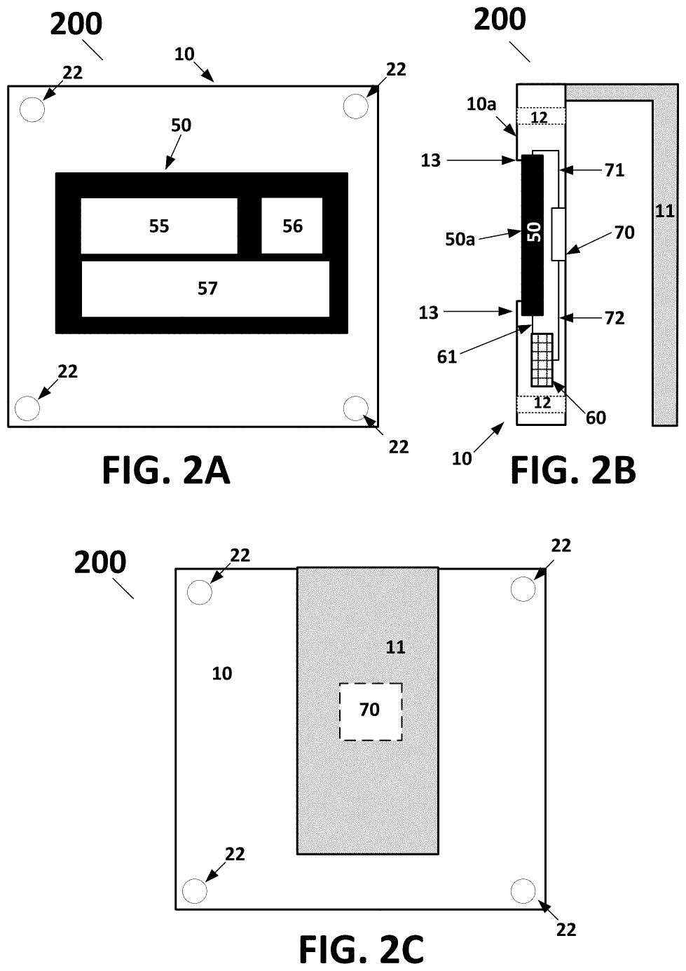

With reference to FIGS. 2A-C, an exemplary MND 200 may have all the characteristics and capabilities as previously described with respect to MND 100. Alternatively, and/or additionally, MND 200 may have a frame 10 that may house an exemplary display 50 and peripheral components processor 60, power source 70, processor connection circuitry 61 between processor 60 and display 50, and power connection circuitry 71/72 between processor 60, display 50, and power source 70. An exemplary processor 60 may comprise an antenna and receiver circuitry and/or other like communication mechanisms known to those skilled in the art to deliver and/or receive information provided by or received via display 50. In an alternative embodiment, the processor 60 may be multiple components located within frame 10 and/or may be part of display 50, including components like antenna and receivers. Additionally, openings 22 may be partially or fully through the thickness of frame 10, such as through-holes 12, to accommodate numerous forms of coupling between frame 10 and exemplary maintenance equipment described herein.

In another aspect of the illustrative embodiment of FIG. 2, a bracket or adaptor 11 may be integrated with and/or mechanically connected to frame 10. In an exemplary embodiment, adaptor 11 may be configured to allow frame 10 to be attached to a structure, such as, for example, any type of service-work device (e.g., sawhorses, maintenance barriers, maintenance signs, door hangers, foldable barriers, prop signs, plastic maintenance gates, security barriers, safety signs, stanchions, partitions). In another exemplary embodiment, adaptor 11 may be situated so that MND 200 cannot be tampered with or have its components removed without proper access. An exemplary power source 70 may be a 9-volt or other portable and/or rechargeable battery. An exemplary power source 70 may also be re-charged by using regular AC power found in most facilities (110-V electric outlets) and/or battery chargers found on devices used to transport MND 200 and/or other maintenance materials (e.g., janitorial baskets, trays, mop holders, maintenance carts, or other mobile charging stations).

In a further aspect of the embodiment illustratively provided for by FIGS. 2A-B, an exemplary frame 10 may be constructed so that the outermost surface 50a of display 50 may be recessed from frame surface 10a while still providing information to viewers via one or more sections, e.g., such as sections 55-57. An exemplary frame 10 according to the embodiment illustratively provided by FIG. 2B may have retaining ridges 13 circumscribing one or more portions of the outside of display 50 to hold the same within frame 10.

As previously described, an exemplary frame 10 in the disclosures herein may be made out of any material or combination of materials suitable to house display 50 and its processor 60 and power source 70. In a preferred embodiment, frame 10 may be lightweight, weatherproof, durable, and easily to sanitize for maintenance-type applications. Alternatively, exemplary frame 10 may be made out of a silicone or vulcanized rubber.

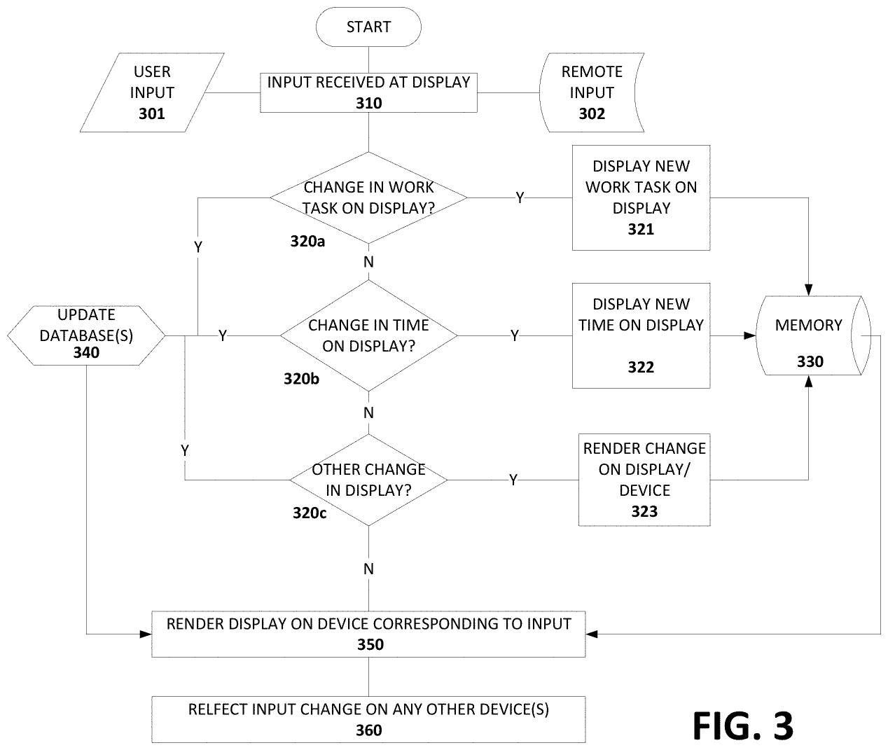

Referring to FIG. 3, an exemplary MND 100/200 may be programmed to receive one or more inputs via its display 50 (Step 310). The inputs to display 50 (including any of its sections) may be from the MND 100/200 user 301 (e.g., the maintenance worker, maintenance worker manager, inspection personnel) or from a remote user 302 (e.g., central authority for maintenance work, central authority for facility in which maintenance work is to be done, emergency/safety personnel (police, firemen, EMT, hospitals)). An exemplary change in display 50 may then be processed for detected changes in work task (Step 320a), changes in times displayed on display 50 (Step 320b), and/or any other change in display 50 (Step 320c), such as changes in LED lighting schemes, font size changes, sounds/lighting of MND 100/200, powering on/off MND 100/200, securing MND 100/200 from any further access). For any change in display accompanying detection steps 320a, 320b, and/or 320c, a corresponding change in the display 50 may result, Step 321, Step 322, and/or Step 323, respectively.

In an exemplary embodiment, an exemplary change in work task pursuant to Step 321 may involve selection from a menu of tasks (e.g., a scroll-bar), or may allow a user to select and display a symbol corresponding to the work task. Alternatively, a specified code may be selected by the user for alerting a reporting station (not shown) of the change in work station task. Any of the aforementioned may be used alone or in combination as part of an exemplary Step 321.

In an exemplary embodiment, an exemplary change in time pursuant to Step 322 may include modifying a clock or using specific buttons to increase or decrease a timing feature (hours, minutes, seconds). Alternatively, the time selection may be based on increments pre-selected for the system 300 and include different increments depending on work tasks previously selected. An exemplary time change display Step 322 may further include updating other display sections on display 50, e.g., changing when next service of area of MND 100/200 will take place, or may update the system 300 so that the maintenance worker will be either unavailable or available earlier than expected due to the change in time.

An exemplary display change pursuant to Step 323 may include a power off or “black-out” screen on one or more sections of display 50. Alternatively, another exemplary display change pursuant to Step 323 may include a change in illumination of one or more sections of display 50 (e.g., increase in brightness or color), an animation in one or more sections of display 50, an increase in the size of the letters or numbers used in one or more sections of display 50, or a sound or verbal notification presented through a speaker or sound emitting device in MND 100/200.

In another aspect of the system 300 illustratively provided by FIG. 3, an exemplary change in display 50 (e.g., Step 321, Step 322, and/or Step 323) may result in storage in memory 330 of the requested changes and/or the change in display 50, such as memory of MND 100/200 and/or memory on a remote computing device or a memory stored on any mobile maintenance equipment. At or around the same time as the requested change in display 50, the system 300 may also update one or more databases in Step 340, such as, for example, databases stored within memory on MND 100/200 or a remote computing device. In an alternative embodiment, the system 300 may also update a calendar database to show a change in scheduling for maintenance at a particular facility or notify change in availability of maintenance personnel.

An exemplary system 300 flow may then render whatever inputs on display 50 at Step 350. Accordingly, the MND 100/200 will reflect the input either immediately or after a confirmation is provided either through a program or from a remote site. In one example, after a maintenance worker changes the time to complete a work task in display 50, the change in time will not be reflected on MND 100/200 until approved and/or re-scheduling of other work tasks and/or other MND 100/200 and reflecting such changes on the same, such as, for example, via an exemplary Step 360.

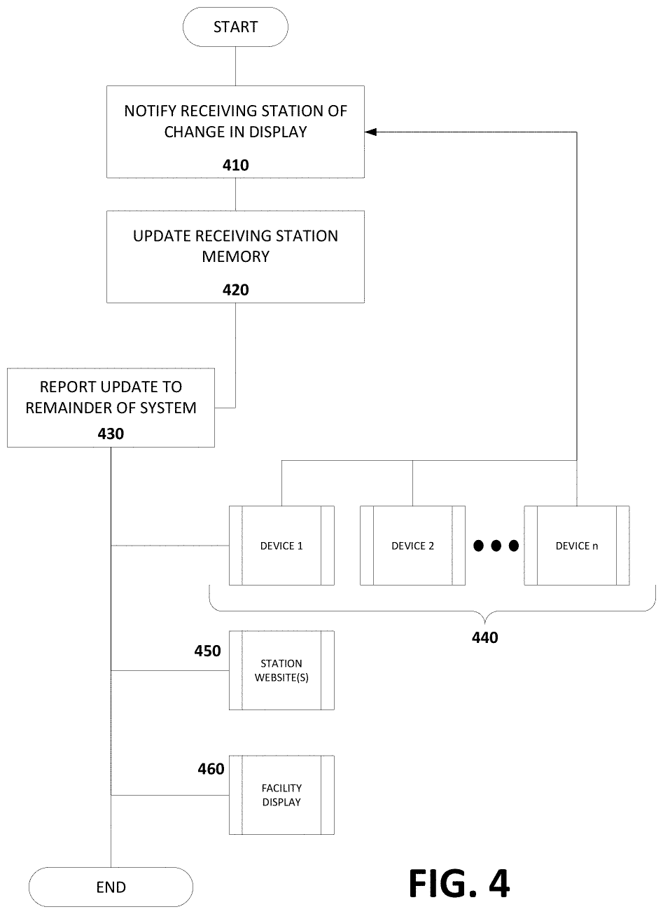

While reference has been to operation of MND 100/200, an exemplary maintenance notification system 400 may further comprise management of inputs from MND 100/200, as illustratively provided for in FIG. 4. According to the exemplary system of FIG. 4, a display change in display 50 is received at a receiving station, such as a command center, management computer, vendor computer, or other remote device at Step 410. Following receipt of the display 50 change, the memory at the receiving station may be updated at Step 420 to log the change for subsequent use. As previously described, the update to the memory of the receiving station may be a change in an outlook calendar, an additional block in a block chain, or a updated table that feeds a timing algorithm.

Referring again to FIG. 4, an exemplary notification system 400 may further include the step of updating any other constituent of the system. In an exemplary updating Step 430, the change recorded at Step 420 may be relayed to the other devices 440 in the network, which may include MND 100/200 located at the same or a different facility, a remote service station, or control station, mobile phones and smart devices (e.g., smart watches, or cellular phones and laptops and tablet devices). Alternatively, the change recorded at Step 420 may be relayed to a website 450 or to one or more displays 460 within the facility, such as, for example, notification screens at airports and bus terminals, lobby displays at hotels, hospitals, and schools, security desk screens, classroom and/or dormitory displays.

An exemplary MND 100/200 may be equipped to connect wirelessly to existing mobile networks or may be wired to a network at a given facility. As such, the MND 100/200 may be programmed to constantly, frequently, periodically, or intermittently transmit information to a remote repository of information for analysis.

An exemplary MND 100/200 may be capable of storage on a maintenance worker tool cart, where it may be configured for charging the battery after use. An exemplary worker tool cart may contain a battery dedicated to charging MND 100/200 through AC power and which may be re-charged by internal electricity generation based on wheeling the cart about the facility, plugging the cart into any appropriate outlets, and/or use of solar energy. In an exemplary embodiment, MND 100/200 may be able to predetermine a display based on the identified location of the worker tool cart, e.g., using a GPS signal received via a receiver on the tool cart and/or the MND 100/200 and/or syncing with the wireless network of the facility to deduce the location of the tool cart. In an alternative embodiment, MND 100/200 may be able to predetermine a work task based on sensors on the tool cart to detect what tools are being used by the maintenance worker. Such sensors may include light and/or pressure sensors that would be in the “off” position when a mop, broom, brush, or cleaner dispenser is placed atop it and would be in the “on” position when one or more of the items are removed. Accordingly, depending on which sensors are “on,” the MND 100/200 would be able to determine the range of work tasks available for selection by a user on display 50. In a further aspect of this embodiment, MND 100/200 may be able to determine based on work tasks what materials or equipment are used to enable monitoring of equipment and inventory of the same (e.g., depletion of given cleanser supplies and/or replacement of towels and/or cleaning tools).

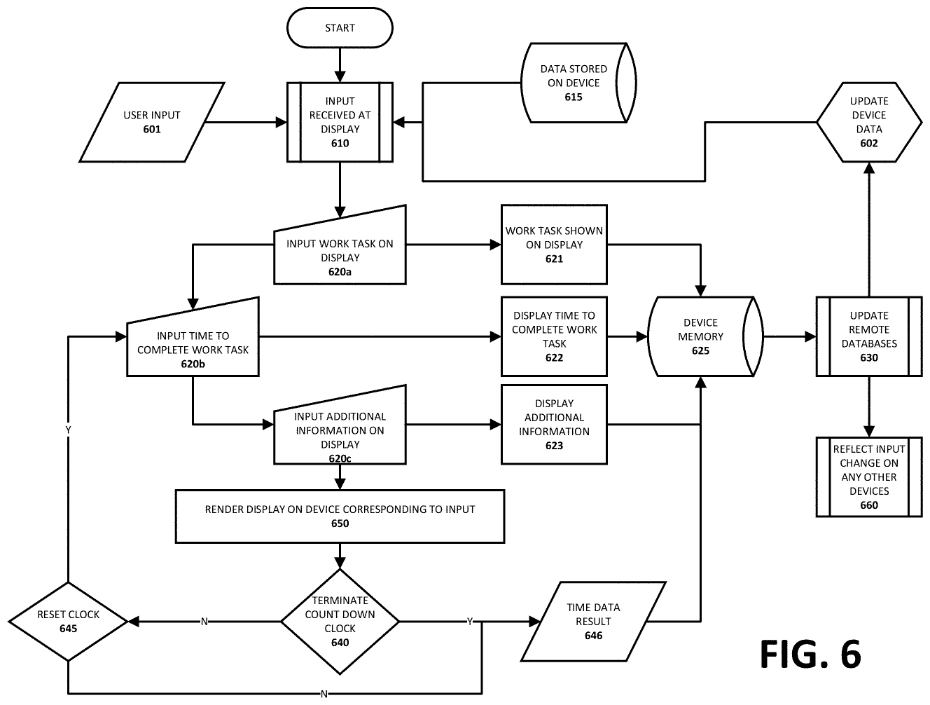

In another exemplary maintenance notification system 400, management of inputs from and to MND 100/200 may be illustratively provided for in FIG. 6.

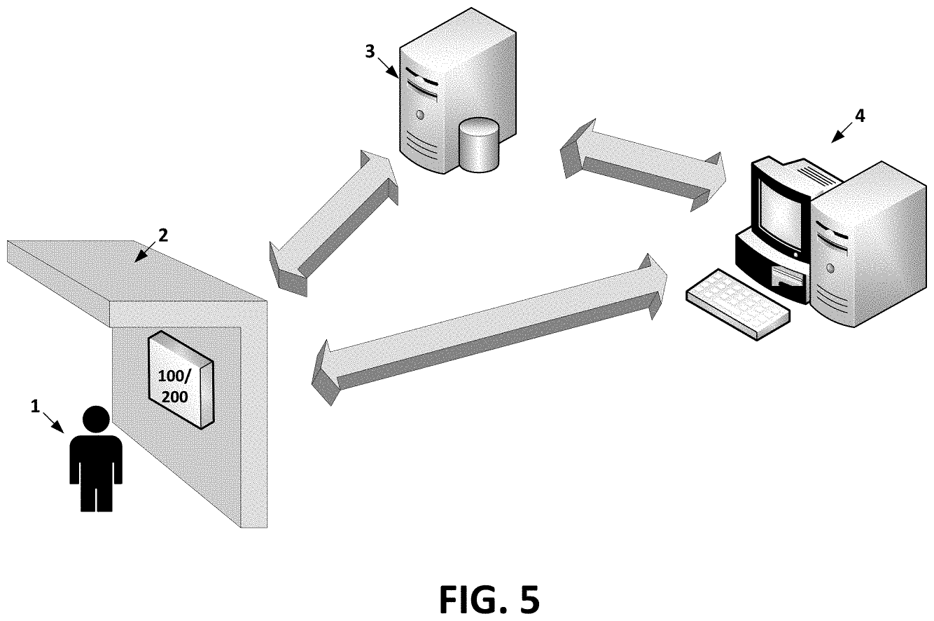

In an exemplary methodology, an exemplary MND 100/200 may receive an input (step 610) that would be displayed. In an exemplary embodiment, the input received in step 610 may be a user input (601) or a form of data stored on the MND 100/200 (615). In a subsequent exemplary step, a work task may be inputted on MND 100/200 (620a), a time to complete a work task may be inputted on MND 100/200 (620b), and/or additional information may be inputted on MND 100/200 (620c). In response to each of the foregoing inputs to MND 100/200, an exemplary system according to FIG. 5 may display the work task (step 621), display the time to complete a work task (step 622), and/or display any additional information (step 623), respectively. Additionally, any displayed information on an MND 100/200, e.g., information 620a-c and/or information displayed via steps 621-623, may be stored in the MND 100/200 memory (625). In an exemplary embodiment, information stored in MND 100/200 memory 625 may also be used to update one or more remote databases (630), which may further include updating and/or creating an input change on any other MND 100/200 in a network (660). In an exemplary embodiment, an updated device profile may be generated (602) and may also serve as an input to MND 100/200 at step 610.

According to an exemplary embodiment, an exemplary process as illustratively provided for in FIG. 6 may receive various inputs (steps 620a-c) and thereafter render the inputs for display on a corresponding MND 100/200 in step 650. Consequently, an exemplary method may also determine whether a count-down clock has terminated (step 640). If the count-down clock has not terminated, then in an exemplary embodiment, a clock reset decision (step 645) may be made. If the clock needs to be reset, an exemplary method according to FIG. 6 may result in a further input of time to complete a work task (step 620b). Alternatively, a time data result may be stored (646) and then subsequently stored in device memory.

As disclosed herein, an exemplary MND 100/200 may receive data for a particular task and may then communicate the data received to one or more locations, e.g., a laptop or remote server, via WiFi or other wired, wireless, digital, or analog communication means known to those skilled in the art. A software protocol configured according to known programming languages, e.g., Visual Basic, C, C++, Java, to operate in accordance with the methodologies of FIGS. 3, 4, and 6, and their variants, may be used to receive inputs in the way of text messages, instant messages, calendar updates/schedules/meetings/notifications such as those available via Microsoft Outlook® and other calendar programs known to those skilled in the art, and update websites, databases, and any aforementioned calendar programs, including those skilled in the art, to provide status updates on work being accomplished via or near MND 100/200.

In an exemplary embodiment, a schedule of work tasks may be input into an exemplary system involving MND 100/200 so that the schedule may be reflected in the MDN 100/200 local memory and all timers for work tasks to be governed by the schedule inputted. In a preferred embodiment, a schedule of work tasks may be sent in an excel spreadsheet to MND 100/200 which may then use its internal processor to read the table to determine the duration a particular task should take and reflect the duration in the form of a timer on the display of the MND 100/200. Alternatively, the system may read the aforementioned table and determine based on the work task to which MND a particular duration may be sent. In this way, the system may discriminate based on work tasks to which MND the duration of a particular work task should be sent.

Further alternatively, the system may queue particular work tasks based on status updates received from particular MND 100/200 and in response deliver a particular queued work task to a different MND 100/200 for handling. According to this further alternative embodiment, an exemplary system may utilize a series of MND 100/200 to provide a complete status update on maintenance required substantially simultaneously at different geographic positions within a facility or workspace.

Additionally, all exemplary embodiments may also use MND 100/200 to provide displays, notifications, or operation commands to peripheral devices (e.g., sirens, alarms, door controls, escalator controls). For example, if an MND 100/200 is provided a schedule for escalator maintenance, the MND 100/200 may then have access to operation controls for the particular escalator so that the escalator is turned off for maintenance to begin at the designated time sent to the MND 100/200. According to such an exemplary embodiment, large geographic areas can alleviate a need for a central control system for peripheral devices and rely on local control of hardware via the MND 100/200 devices located in close geographic proximity. Alternatively, MND 100/200 may be used to provide an additional layer of safety control in addition to any central control of peripheral devices for which maintenance is required.

While FIG. 3, FIG. 4, and FIG. 6 may illustrate exemplary methods of use of an MND 100/200, these methods may be used in combination and may take place simultaneously or consecutively and may be operated in any order besides the ones illustratively provided.

Any one or more of the devices and methods identified may be combined or interchanged to serve a particular purpose or multiple purposes in accordance with the disclosures herein. Furthermore, any one of the systems, sub-systems, and embodiments may be interchanged, combined, and/or modified in view of any other to achieve the benefits identified as well as those which are inherent from the disclosures contained herein.

A notification device may have a frame with at least one portion to securely attach to a standing structure, a display coupled to the frame that has at least one section for visibly conveying one of an activity or a period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device.

A notification device may have a frame with at least one portion to securely attach to a standing structure, a display coupled to the frame that has at least one section for visibly conveying one of an activity or a period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device and configured to deliver the information when the period of time elapses.

A notification device may have a frame with at least one portion to securely attach to a standing structure, a display coupled to the frame that has at least one section for visibly conveying one of an activity or a period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device. In this embodiment, the location external of the notification device is a location that provided information that caused the processor to make the at least one real-time visible update to the at least one section of the display processor.

A notification device may have a frame with at least one portion to securely attach to a standing structure, a display coupled to the frame that has at least one section for visibly conveying one of an activity or a period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device and configured to deliver the information when the period of time elapses. In this embodiment, the location external of the notification device is a location that provided information that caused the processor to make the at least one real-time visible update to the at least one section of the display processor.

A notification device may have a frame with at least one portion to securely attach to a standing structure, a display coupled to the frame that has at least one section for visibly conveying one of an activity or a period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device. Further additionally, the display comprises a plurality of sections for visibly conveying an activity, wherein each one of the plurality of sections includes a first time and a second time within the period of time.

A notification device may have a frame with at least one portion to securely attach to a standing structure, a display coupled to the frame that has at least one section for visibly conveying one of an activity or a period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device and configured to deliver the information when the period of time elapses. Further additionally, the display comprises a plurality of sections for visibly conveying an activity, wherein each one of the plurality of sections includes a first time and a second time within the period of time.

A notification device may have a frame with at least one portion to securely attach to a standing structure, a display coupled to the frame that has at least one section for visibly conveying one of an activity or a period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device. Further additionally, the display comprises a plurality of sections for visibly conveying an activity, wherein each one of the plurality of sections includes a first time and a second time within the period of time. In this embodiment, the location external of the notification device is a location that provided information that caused the processor to make the at least one real-time visible update to the at least one section of the display processor.

A notification device may have a frame with at least one portion to securely attach to a standing structure, a display coupled to the frame that has at least one section for visibly conveying one of an activity or a period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device and configured to deliver the information when the period of time elapses. Further additionally, the display comprises a plurality of sections for visibly conveying an activity, wherein each one of the plurality of sections includes a first time and a second time within the period of time. In this embodiment, the location external of the notification device is a location that provided information that caused the processor to make the at least one real-time visible update to the at least one section of the display processor.

A notification device may have a frame with at least one portion to securely attach to a standing structure, a display coupled to the frame that has at least one section for visibly conveying one of an activity or a period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device. Further additionally, the display comprises a plurality of sections for visibly conveying an activity, wherein each one of the plurality of sections includes a first time and a second time within the period of time.

A notification device may have a frame with at least one portion to securely attach to a standing structure, a display coupled to the frame that has at least one section for visibly conveying one of an activity or a period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device and configured to deliver the information when the period of time elapses. Further additionally, the display comprises a plurality of sections for visibly conveying an activity, wherein each one of the plurality of sections includes a first time and a second time within the period of time.

A notification device may have a frame with at least one portion to securely attach to a standing structure, a display coupled to the frame that has at least one section for visibly conveying one of an activity or a period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device. Further additionally, the display comprises a plurality of sections for visibly conveying an activity, wherein each one of the plurality of sections includes a first time and a second time within the period of time. In this embodiment, the location external of the notification device is a location that provided information that caused the processor to make the at least one real-time visible update to the at least one section of the display processor.

A notification device may have a frame with at least one portion to securely attach to a standing structure, a display coupled to the frame that has at least one section for visibly conveying one of an activity or a period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device and configured to deliver the information when the period of time elapses. Further additionally, the display comprises a plurality of sections for visibly conveying an activity, wherein each one of the plurality of sections includes a first time and a second time within the period of time. In this embodiment, the location external of the notification device is a location that provided information that caused the processor to make the at least one real-time visible update to the at least one section of the display processor.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device. Further additionally, the display comprises a plurality of sections for visibly conveying an activity, wherein each one of the plurality of sections includes a first time and a second time within the period of time.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device and configured to deliver the information when the period of time elapses. Further additionally, the display comprises a plurality of sections for visibly conveying an activity, wherein each one of the plurality of sections includes a first time and a second time within the period of time.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device. Further additionally, the display comprises a plurality of sections for visibly conveying an activity, wherein each one of the plurality of sections includes a first time and a second time within the period of time. In this embodiment, the location external of the notification device is a location that provided information that caused the processor to make the at least one real-time visible update to the at least one section of the display processor.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device and configured to deliver the information when the period of time elapses. Further additionally, the display comprises a plurality of sections for visibly conveying an activity, wherein each one of the plurality of sections includes a first time and a second time within the period of time. In this embodiment, the location external of the notification device is a location that provided information that caused the processor to make the at least one real-time visible update to the at least one section of the display processor.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device. Further additionally, the display comprises a plurality of sections for visibly conveying an activity, wherein each one of the plurality of sections includes a first time and a second time within the period of time.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device and configured to deliver the information when the period of time elapses. Further additionally, the display comprises a plurality of sections for visibly conveying an activity, wherein each one of the plurality of sections includes a first time and a second time within the period of time.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device. Further additionally, the display comprises a plurality of sections for visibly conveying an activity, wherein each one of the plurality of sections includes a first time and a second time within the period of time. In this embodiment, the location external of the notification device is a location that provided information that caused the processor to make the at least one real-time visible update to the at least one section of the display processor.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device and configured to deliver the information when the period of time elapses. Further additionally, the display comprises a plurality of sections for visibly conveying an activity, wherein each one of the plurality of sections includes a first time and a second time within the period of time. In this embodiment, the location external of the notification device is a location that provided information that caused the processor to make the at least one real-time visible update to the at least one section of the display processor.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device. Further additionally, the display comprises a plurality of sections for visibly conveying an activity, wherein each one of the plurality of sections includes a first time and a second time within the period of time.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device and configured to deliver the information when the period of time elapses. Further additionally, the display comprises a plurality of sections for visibly conveying an activity, wherein each one of the plurality of sections includes a first time and a second time within the period of time.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device. Further additionally, the display comprises a plurality of sections for visibly conveying an activity, wherein each one of the plurality of sections includes a first time and a second time within the period of time. In this embodiment, the location external of the notification device is a location that provided information that caused the processor to make the at least one real-time visible update to the at least one section of the display processor.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device and configured to deliver the information when the period of time elapses. Further additionally, the display comprises a plurality of sections for visibly conveying an activity, wherein each one of the plurality of sections includes a first time and a second time within the period of time. In this embodiment, the location external of the notification device is a location that provided information that caused the processor to make the at least one real-time visible update to the at least one section of the display processor.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device. Further additionally, the display comprises a plurality of sections for visibly conveying an activity, wherein each one of the plurality of sections includes a first time and a second time within the period of time.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device and configured to deliver the information when the period of time elapses. Further additionally, the display comprises a plurality of sections for visibly conveying an activity, wherein each one of the plurality of sections includes a first time and a second time within the period of time.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device. Further additionally, the display comprises a plurality of sections for visibly conveying an activity, wherein each one of the plurality of sections includes a first time and a second time within the period of time. In this embodiment, the location external of the notification device is a location that provided information that caused the processor to make the at least one real-time visible update to the at least one section of the display processor.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device and configured to deliver the information when the period of time elapses. Further additionally, the display comprises a plurality of sections for visibly conveying an activity, wherein each one of the plurality of sections includes a first time and a second time within the period of time. In this embodiment, the location external of the notification device is a location that provided information that caused the processor to make the at least one real-time visible update to the at least one section of the display processor.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device. The notification device may also further comprise an adaptor connected to the frame.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device and configured to deliver the information when the period of time elapses. The notification device may also further comprise an adaptor connected to the frame.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device. The notification device may also further comprise an adaptor connected to the frame. In this embodiment, the location external of the notification device is a location that provided information that caused the processor to make the at least one real-time visible update to the at least one section of the display processor.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device and configured to deliver the information when the period of time elapses. The notification device may also further comprise an adaptor connected to the frame. In this embodiment, the location external of the notification device is a location that provided information that caused the processor to make the at least one real-time visible update to the at least one section of the display processor.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device. The notification device may also further comprise an adaptor connected to the frame.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device and configured to deliver the information when the period of time elapses.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device. The notification device may also further comprise an adaptor connected to the frame. In this embodiment, the location external of the notification device is a location that provided information that caused the processor to make the at least one real-time visible update to the at least one section of the display processor.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device and configured to deliver the information when the period of time elapses. In this embodiment, the location external of the notification device is a location that provided information that caused the processor to make the at least one real-time visible update to the at least one section of the display processor. The notification device may also further comprise an adaptor connected to the frame.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device and configured to deliver the information when the period of time elapses. Further additionally, the display comprises a plurality of sections for visibly conveying an activity, wherein each one of the plurality of sections includes a first time and a second time within the period of time.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device. Further additionally, the display comprises a plurality of sections for visibly conveying an activity, wherein each one of the plurality of sections includes a first time and a second time within the period of time. In this embodiment, the location external of the notification device is a location that provided information that caused the processor to make the at least one real-time visible update to the at least one section of the display processor.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device and configured to deliver the information when the period of time elapses. Further additionally, the display comprises a plurality of sections for visibly conveying an activity, wherein each one of the plurality of sections includes a first time and a second time within the period of time. In this embodiment, the location external of the notification device is a location that provided information that caused the processor to make the at least one real-time visible update to the at least one section of the display processor.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device. Further additionally, the display comprises a plurality of sections for visibly conveying an activity, wherein each one of the plurality of sections includes a first time and a second time within the period of time.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device and configured to deliver the information when the period of time elapses. Further additionally, the display comprises a plurality of sections for visibly conveying an activity, wherein each one of the plurality of sections includes a first time and a second time within the period of time.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device. Further additionally, the display comprises a plurality of sections for visibly conveying an activity, wherein each one of the plurality of sections includes a first time and a second time within the period of time. In this embodiment, the location external of the notification device is a location that provided information that caused the processor to make the at least one real-time visible update to the at least one section of the display processor.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device and configured to deliver the information when the period of time elapses. Further additionally, the display comprises a plurality of sections for visibly conveying an activity, wherein each one of the plurality of sections includes a first time and a second time within the period of time. In this embodiment, the location external of the notification device is a location that provided information that caused the processor to make the at least one real-time visible update to the at least one section of the display processor.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device. The notification device may also further comprise a tamper-resistant adaptor connected to the frame.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device and configured to deliver the information when the period of time elapses. The notification device may also further comprise a tamper-resistant adaptor connected to the frame.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device. The notification device may also further comprise a tamper-resistant adaptor connected to the frame. In this embodiment, the location external of the notification device is a location that provided information that caused the processor to make the at least one real-time visible update to the at least one section of the display processor.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device and configured to deliver the information when the period of time elapses. The notification device may also further comprise a tamper-resistant adaptor connected to the frame. In this embodiment, the location external of the notification device is a location that provided information that caused the processor to make the at least one real-time visible update to the at least one section of the display processor.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device. The notification device may also further comprise a tamper-resistant adaptor connected to the frame.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device and configured to deliver the information when the period of time elapses.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device. The notification device may also further comprise a tamper-resistant adaptor connected to the frame. In this embodiment, the location external of the notification device is a location that provided information that caused the processor to make the at least one real-time visible update to the at least one section of the display processor.

A notification device may have a frame with at least one portion to securely attach to a standing structure, a display coupled to the frame that has at least one section for visibly conveying one of an activity or a period of time, the display comprising a plurality of sections for visibly conveying an activity, wherein each one of the plurality of sections includes a first time and a second time within the period of time, a battery for powering the display, and a processor electrically connected to the display and configured to make at least one real-time visible update to the at least one section of the display after the period of time elapses. Additionally, the notification device processor is configured to deliver information related to the at least one update to a location external of the notification device and configured to deliver the information when the period of time elapses. In this embodiment, the location external of the notification device is a location that provided information that caused the processor to make the at least one real-time visible update to the at least one section of the display processor. The notification device may also further comprise a tamper-resistant adaptor connected to the frame.

Many further variations and modifications may suggest themselves to those skilled in art upon making reference to above disclosure and foregoing interrelated and interchangeable illustrative embodiments, which are given by way of example only, and are not intended to limit the scope and spirit of the interrelated embodiments of the invention described herein.

The invention claimed is:

1. A notification device, comprising:
a frame comprising at least one portion to securely attach to a standing structure;
a display coupled to the frame, wherein the display comprises at least one section for visibly conveying one of an activity or a period of time;
a battery for powering the display; and
a processor electrically connected to the display and configured to make at least one real-time visible update to the at least one section of the display after the period of time elapses,
wherein the processor is further configured to deliver information related to the at least one update to a location external of the notification device.

2. The notification device of claim 1, wherein the processor is further configured to deliver the information when the period of time elapses.

3. The notification device of claim 1, wherein the location external of the notification device is a location that provided information that caused the processor to make the at least one real-time visible update to the at least one section of the display processor.

4. The notification device of claim 1, wherein the display comprises a plurality of sections for visibly conveying an activity, wherein each one of the plurality of sections includes a first time and a second time within the period of time.

5. The notification device of claim 1, further comprising an adaptor connected to the frame.

6. The notification device of claim 5, wherein the adaptor is substantially tamper-resistant.

7. The notification device of claim 5, wherein the adaptor is integral with the frame.

8. The notification device of claim 1, wherein the display comprises an LCD screen.

9. The notification device of claim 1, wherein the display comprises at least one LED.

10. The notification device of claim 1, wherein the display comprises an LCD screen and at least one LED.

11. The notification device of claim 1, further comprising an adaptor connected to the frame and a display comprising an LCD screen or at least one LED.

12. A method of controlling a remote maintenance device, comprising the steps of:
receiving a scheduled maintenance task;
displaying a duration of the scheduled maintenance task via an electronic display coupled to a frame located at a site for the scheduled maintenance task;
updating the electronic display on or before the duration has elapsed; and
delivering information related to the updating of the display to a remote source.

13. The method of claim 12, wherein the step of updating the display includes updating a display of information other than the duration of the scheduled maintenance task.

14. The method of claim 13, wherein the information other than the duration of the scheduled maintenance task includes a text message on the electronic display.

15. The method of claim 12, further comprising displaying text related to the scheduled maintenance task via the electronic display.

16. The method of claim 15, further comprising displaying text related to the scheduled maintenance task via a second electronic display.

17. The method of claim 12, wherein the remote source is the source of the scheduled maintenance task.

18. A notification system, comprising:
at least one notification device comprising:
a frame comprising at least one portion to securely attach the at least one notification device to a standing structure;
a display coupled to the frame, wherein the display comprises at least one section for visibly conveying one of an activity or a period of time;
a battery for powering the display; and
a processor electrically connected to the display and configured to make at least one real-time visible update to the at least one section of the display after the period of time elapses,
wherein the processor is further configured to deliver information related to the at least one update to a server;
and
the standing structure.

19. The system of claim 18, further comprising the at least one server.

20. The system of claim 20, wherein at least one server delivers instructions to make at least one real-time visible update to the at least one notification device.
